(19) United States
(12) Patent Application Publication
(10) Pub. No.: US 2014/0268413 A1
(43) Pub. Date: Sep. 18, 2014

(54) SPINDLE MOTOR AND HARD DISC DRIVE INCLUDING THE SAME

(71) Applicant: SAMSUNG ELECTRO-MECHANICS CO., LTD., Suwon (KR)

(72) Inventors: Jae Woon PARK, Suwon (KR); Tae Young CHOI, Suwon (KR); Shin Young CHEONG, Suwon (KR); Hyun Chul LEE, Suwon (KR)

(73) Assignee: SAMSUNG ELECTRO-MECHANICS CO., LTD., Suwon (KR)

(21) Appl. No.: 14/291,902

(22) Filed: May 30, 2014

Related U.S. Application Data
(62) Division of application No. 13/564,290, filed on Aug. 1, 2012.

(30) Foreign Application Priority Data
Aug. 2, 2011 (KR) 10-2011-0077000
Mar. 29, 2012 (KR) 10-2012-0032342
Jun. 29, 2012 (KR) 10-2012-0071344

(51) Int. Cl. G11B 19/20; H02K 1/18

(52) U.S. Cl. CPC G11B 19/2036; H02K 1/187
USPC 360/99.08; 310/216.113

(57) ABSTRACT

A spindle motor includes a shaft; a sleeve rotatably supporting the shaft by fluid dynamic pressure; a holder provided outwardly of the sleeve and at least partially formed of a magnetic material; a stator core mounted on an outer surface of the holder; and a base member including a mounting part protruding upwardly in an axial direction and fixed to the holder. The holder has a core seating part protruding outwardly therefrom, and an upper surface of the stator core is seated on the core seating part.

### CROSS-REFERENCE TO RELATED APPLICATIONS

This application is a divisional of U.S. application Ser. No. 13/564,290, filed on Aug. 1, 2012, which claims the priority of Korean Patent Application Nos. 10-2011-0077000 filed on Aug. 2, 2011, 10-2012-0032342 filed on Mar. 29, 2012 and 10-2012-0071344 filed on Jun. 29, 2012, in the Korean Intellectual Property Office, the disclosures of which are incorporated herein by reference.

### BACKGROUND

1. Field

The present invention relates to a spindle motor and a hard disk drive including the same.

2. Description of the Related Art

A hard disk drive (HDD), an information storage device, reads data stored on a disk or writes data to a disk using a read/write head.

The hard disk drive requires a disk driving device capable of driving a disk. In the disk driving device, a small spindle motor is used.

This small-sized spindle motor has used a hydrodynamic bearing assembly. A shaft, a rotating member of the hydrodynamic bearing assembly, and a sleeve, a fixed member thereof, have a lubricating fluid interposed therebetween, such that the shaft is supported by pressure generated in the lubricating fluid.

In addition, a rotor hub rotating together with the shaft and having a recording disk mounted thereon may be disposed on an upper portion of the shaft, and the rotor hub is fixedly coupled to the upper portion of the shaft and has a disk shape in which it is extended in a radial direction based on the shaft. Therefore, the lubricating fluid may also be interposed between an upper surface of the sleeve and the rotor hub.

According to the related art, in manufacturing a base provided in the hard disk drive, a post-processing scheme of die-casting aluminum (Al) and then removing burrs or the like, generated due to the die-casting process has been used.

However, in the die-casting scheme according to the related art, since a process of injecting aluminum (Al) in a molten state into a mold to make a form is performed, large amounts of temperature and pressure are required, such that a large amount of energy may be required in the process and processing time and costs may be increased.

Therefore, in order to solve the problems of the die-casting process, an attempt to manufacture the base through a plastic working process such as press working, or the like, has been conducted. However, in the case of manufacturing the base by press working, since the base may have a uniform thickness, a problem may be generated in coupling a core to the base.

That is, in the case in which a base is manufactured in a die-casting process, the base may be provided with a step, so as to seat the core thereon. However, in the case in which a base is manufactured by pressing a plate material having a uniform thickness, since the thickness of the base is uniform, it may be difficult to form a core seating part on the base.

Further, a base manufactured by the die-casting process according to the related art is generally formed of a non-magnetic material. In the case in which the stator core is provided on the core seating part provided on the base, magnetic flux may not flow smoothly, such that rotational force of the hub may be insufficient.

Japanese Patent Laid-Open Publication No. 2007-198555 discloses that a die-casting base is provided with a step to seat a core thereon.

### SUMMARY

An aspect of the present invention provides a spindle motor including a base manufactured by plastic working such as press working, or the like, and having a core stably and easily seated on a holder capable of allowing magnetic flux to flow smoothly.

According to an aspect of the present invention, there is provided a spindle motor including: a shaft; a sleeve rotatably supporting the shaft by fluid dynamic pressure; a holder provided outwardly of the sleeve and at least partially formed of a magnetic material; a stator core mounted on an outer surface of the holder; and a base member including a mounting part protruding upwardly in an axial direction and fixed to the holder.

The mounting part may be fitted between the sleeve and the holder.

The mounting part may be coupled to the outer surface of the holder in a radial direction.

The spindle motor may further include a connecting part interposed between the sleeve and the holder.

The connecting part may be formed integrally with at least one of the sleeve and the holder.

The holder may have a core seating part protruding outwardly therefrom, and the core seating part may have the stator core seated thereon.

An upper surface or a lower surface of the stator core may be bonded to the core seating part.

The mounting part may have the same height as that of the core seating part, and a lower surface of the stator core may be simultaneously coupled to the mounting part and the core seating part.

A rotor hub may be coupled to an upper end of the shaft.

The rotor hub may include a main wall part extended downwardly in the axial direction and having an inner surface facing at least a portion of an outer surface of the sleeve and an outer surface facing at least a portion of an inner surface of the holder.

The outer surface of the main wall part and the inner surface of the holder may form a labyrinth seal.

The base member may be formed by performing plastic working on a rolled steel sheet.

The holder may be entirely formed of a magnetic material.

The holder may be formed by plating or coating a non-magnetic metal with a magnetic metal.

The holder may be formed by performing corrosion resistant coating or painting on a magnetic metal.

According to another aspect of the present invention, there is provided a hard disk drive including: the spindle motor as described above rotating a disk by power applied through a substrate; a magnetic head writing data to the disk and reading data from the disk; and a head transfer part transferring the magnetic head to a predetermined position on the disk.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1 and 2 are cross-sectional views showing a spindle motor according to embodiments of the present invention;

FIGS. 3 and 4 are perspective views showing modified examples of a holder in the embodiments of FIGS. 1 and 2;

FIGS. 5 through 7 are cross-sectional views showing a spindle motor according to embodiments of the present invention; and

FIG. 8 is a cross-sectional view of a disk driving device using a spindle motor according to an embodiment of the present invention.

### DETAILED DESCRIPTION OF THE PREFERRED EMBODIMENTS

Embodiments of the present invention will be described in detail with reference to the accompanying drawings. However, it should be noted that the spirit of the present invention is not limited to the embodiments set forth herein and that those skilled in the art and understanding the present invention could easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

FIG. 1 is a cross-sectional view showing a spindle motor according to an embodiment of the present invention.

Referring to FIG. 1, a spindle motor 100 according to the embodiment of the present invention may include a hydrodynamic bearing assembly 110 including a shaft 111, a sleeve 112, a rotor hub 121, a stopper 111a and a cover member 115, a rotor 120 including the rotor hub 121, and a stator 130 including a core 131 having a coil 132 wound therearound.

The hydrodynamic bearing assembly 110 may include the rotor hub 121. Here, the rotor hub 121 may be a component configuring the hydrodynamic bearing assembly 110 while configuring the rotor 120 to be described below.

In addition, a rotating member assembly may include the shaft 111 and the rotor hub 121 mounted on the shaft 111.

Terms with respect to directions will first be defined. As viewed in FIG. 1, an axial direction refers to a vertical direction based on the shaft 111, and an outer radial direction and an inner radial direction refers to a direction toward an outer edge of the rotor hub 121 based on the shaft 111 and a direction toward the center of the shaft 111 based on the outer edge of the rotor hub 121, respectively.

Further, in the following description, a rotating member may include the shaft 111, the rotor 120 including the rotor hub 121, and a magnet 125 mounted on the rotor 120, and the like, while a fixed member may include members other than the rotating member and relatively fixed to the rotating member, such as the sleeve 112, a holder 114, the stator 130, a base member 133, and the like.

In addition, a communication path between an interface of a lubricating fluid and the outside means a path through which the interface of the lubricating fluid is connected to the outside of the spindle motor and may have air introduced and discharged therethrough.

The sleeve 112 may support the shaft 111 so that an upper end of the shaft 111 protrudes upwardly in an axial direction. The sleeve 112 may be formed by forging Cu or Al or sintering a Cu—Fe-based alloy powder or a SUS-based powder. However, the sleeve is not limited to being manufactured by the above-mentioned method, and may be manufactured by various methods.

Here, the shaft 111 may be inserted into a shaft hole of the sleeve 112 so as to have a micro clearance therebetween, thereby forming a bearing clearance C. The bearing clearance C may be filled with the lubricating fluid (hereinafter, both “lubricating fluid” and “oil” are used interchangeably). At least one of an outer diameter of the shaft 111 and an inner diameter of the sleeve 112 may be provided with upper and lower radial dynamic pressure grooves 112a. At the time of rotation of the rotor 120, a radial bearing may be generated by the radial dynamic pressure grooves 112a, and the rotor may rotate smoothly thereby.

The spindle motor 100 according to the embodiment of the present invention may use a fluid bearing and generally include a pair of upper and lower radial dynamic pressure grooves for rotational stability, such that two hydrodynamic bearings may be formed when the motor is driven.

That is, the radial dynamic pressure grooves 112a may generate fluid dynamic pressure at the time of the rotation of the shaft 111 so that the shaft 111 may rotate smoothly in a state in which the shaft is spaced apart from the sleeve 112 by a predetermined interval, thereby serving as a bearing.

However, the radial dynamic pressure grooves 112a are not limited to being formed in the inner side of the sleeve 112 as described above, but may also be formed in an outer diameter surface of the shaft 111. In addition, the number of radial dynamic pressure grooves 112a is not particularly limited.

Here, the radial dynamic pressure groove 112a may have any one of a herringbone shape, a spiral shape, and a helical shape. However, the radial dynamic pressure groove 112a may have any shape, as long as it can generate radial dynamic pressure.

The sleeve 112 may be provided with a circulation-hole 112c allowing upper and lower portions thereof to be in communication with each other. The circulation hole 112c may disperse pressure of the lubricating fluid in an inner portion of the hydrodynamic bearing assembly 110 to be balanced and allow air bubbles, or the like, present in the inner portion of the hydrodynamic bearing assembly 110 to move so as to be discharged by circulation.

Here, the shaft 111 may include the stopper 111a provided on a lower end portion thereof and protruding in the outer radial direction, and the stopper 111a may be caught by a lower end surface of the sleeve 112 to limit floatation of the shaft 111 and the rotor 120.

Meanwhile, a groove shaped reservoir part 112b may be formed in at least one of the sleeve 112 and the shaft 111 between the upper and lower radial dynamic pressure grooves 112a so that the bearing clearance between the sleeve 112 and the shaft 111 may be wider therein, as compared to other portions. Although a case in which the reservoir part 112b is provided on an inner peripheral surface of the sleeve 112 in a circumferential direction is shown in FIG. 1, the present invention is not limited thereto. The reservoir part may be provided on an outer peripheral surface of the shaft 111 in a circumferential direction.

In addition, the sleeve 112 may include a thrust dynamic pressure groove formed in an upper surface thereof to generate thrust dynamic pressure at the time of the rotation of the shaft. The thrust dynamic pressure groove is not limited to being formed in the sleeve 112, but may also be formed in the rotor hub 121 facing the upper surface of the sleeve 112. The thrust dynamic pressure groove may have various shapes, such as a spiral shape, a herringbone shape, a helical shape, and the like.

Meanwhile, the cover member 115 may be coupled to the lower portion of the sleeve 112 in the axial direction while covering the shaft hole of the sleeve 112 to prevent leakage of the lubricating fluid.

Here, the cover member 115 may receive the lubricating fluid in a clearance formed between a lower surface of the shaft 111 and the cover member 115, thereby serving as a bearing supporting the lower surface of the shaft 111 at the time of the rotation of the shaft 111.

The holder 114 may be provided outwardly of the sleeve 112. The sleeve 112 may serve to support the shaft 111 and form the hydrodynamic bearing assembly, and the holder 114 may serve to fix the stator core 131 to be described below.

A main wall part 126 extended from the rotor hub 121 downwardly in the axial direction may have an inner surface facing at least a portion of the outer surface of the sleeve 112 and an outer surface facing at least a portion of an inner surface of the holder 114. That is, the main wall part 126 may be disposed between the sleeve 112 and the holder 114. In this case, the outer surface of the main wall part 126 and the inner surface of the holder 114 may form a labyrinth seal. Therefore, scattering or leakage of the oil may be significantly reduced.

In addition, the holder 114 may include a core seating part 114a stepped on an outer surface thereof to allow a lower portion of the stator core 131 to be caught, thereby guiding a position of the stator core 131 to be fixed in the axial direction. The stator core 131 may be bonded to the core seating part 114a.

As shown in FIG. 1, the holder 114 according to the embodiment of the present invention may include the core seating part 114a stepped on the outer surface thereof. The core seating part 114a may be formed by forming a step at an approximately central portion of the outer surface of the holder 114 to allow an upper portion of the holder 114 to be thinner than a lower portion thereof based on the step.

Meanwhile, modified examples of the holder 114 according to the embodiment of the present invention are shown in FIGS. 3 and 4. That is, a part protruding from the outer surface of the holder 114 in a ring shape may be formed to serve as the core seating part 114a (an example of FIG. 3). Further, the part protruding in the ring shape may be discontinuously provided in the circumferential direction (an example of FIG. 4).

In this case, a parallelism between a surface of the core seating part 114a on which the stator core 131 is seated and the upper surface of the sleeve 112 in which the thrust dynamic pressure bearing is formed may be 50 μm or less, and a perpendicularity between the surface of the core seating part 114a on which the stator core 131 is seated and the inner surface of the sleeve 112 in which the radial dynamic pressure bearing is formed may be 50 μm or less. That is, an error range of the parallelism and the perpendicularity may be 50 μm or less.

In addition, the holder 114 may be formed of a magnetic material. A base manufactured by a die-casting process according to the related art may be generally formed of a non-magnetic material, and in the case in which the stator core is provided on the core seating part provided in the base, magnetic flux may not flow smoothly, such that rotational force of the rotor hub may be insufficient. However, according to the embodiment of the present invention, the holder 114 may be formed of the magnetic material, thereby allowing the magnetic flux to flow smoothly.

That is, as a material of the holder 114, a magnetic metal, a material formed by plating or coating a non-magnetic metal with a magnetic material, a material formed by plating or coating a magnetic metal, or the like, may be used.

First, as the magnetic metal for the holder 114, iron (Fe), cobalt (Co), nickel (Ni), magnetic stainless steel, or the like may be used.

Next, as the material formed by plating or coating a non-magnetic metal with a magnetic material, a material formed by plating an Fe based metal or a brass based metal with nickel (Ni) or coating the Fe based metal or the brass based metal with chromium (Cr) may be used. That is, even in the case that an inner portion of the holder 114 is formed of the non-magnetic material, the outer surface of the holder 114 may be coated with the magnetic material such as nickel (Ni), chromium (Cr), or the like, to allow the magnetic flux to flow smoothly. For example, a material formed by plating or coating brass with nickel, or a material formed by plating or coating aluminum with nickel may be used.

Finally, as the material of the holder 114, the material formed by plating or coating a magnetic metal may be used. In the case in which the inner portion of the holder 114 is formed of the magnetic metal, a material to be plated or coated is not necessary to be a magnetic material. In this case, a material formed by performing corrosion resistant coating or painting may be used in order to prevent corrosion of the magnetic material.

Further, a mounting part 134 protruding from the base member 133 upwardly in the axial direction may be fitted between the sleeve 112 and the holder 114. In more detail, the mounting part 134 may be fitted into and coupled to a space formed between the sleeve 112 and the holder 114 that are spaced apart from each other by a predetermined interval. That is, the mounting part 134 may be fitted into the space formed between the sleeve 112 and the holder 114. In other words, the sleeve 112 may be coupled to an inner surface of the mounting part 134 of the base member 133, and the inner surface of the holder 114 may be coupled to an outer surface of the mounting part 134.

In the case in which the mounting part 134 is fitted into the space formed between the sleeve 112 and the holder 114, the mounting part 134 may be bonded to the sleeve 112 and the holder 114. That is, a bond may be applied to the space formed between the sleeve 112 and the holder 114, and the mounting part 134 may be slid and coupled to the space to thereby be fixed thereto. In this case, the bond may be applied to the sleeve 112 and the holder 114.

Further, the coupling method is not limited to the sliding or bonding method, but may also use a press-fitting method, a welding method, or the like. In the case of the press-fitting method, the mounting part 134 may be press-fitted into at least one of the sleeve 112 and the holder 114.

The method of coupling between the mounting part 134 and the sleeve 112 and the method of coupling between the mounting part 134 and the holder 114 may be different. For example, the mounting part 134 may be slid and bonded to the sleeve 112 and be press-fitted in and welded to the holder 114.

The rotor hub 121, a rotating member coupled to the shaft 111 and rotating together with the shaft 111, may configure the rotor 120 while configuring the hydrodynamic bearing assembly 110. Hereinafter, the rotor 120 will be described in detail.

The rotor 120 may be a rotating structure provided to be rotatable with respect to the stator 130 and include the rotor hub 121 having the annular ring-shaped magnet 125 provided on an inner peripheral surface thereof, wherein the annular ring-shaped magnet 125 corresponds to the stator core 131 to be described below, having a predetermined interval therebetween.

In other words, the rotor hub 121 may be a rotating member coupled to the shaft 111 to rotate together with the shaft 111. Here, the shaft 111 and the rotor hub 121 may include an adhesive applied therebetween to thereby be fixed to each other. However, the shaft 111 and the rotor hub 121 are not limited to being fixed to each other in the above-mentioned method, but may be fixed to each other in various methods such as a welding method, a press-fitting method, and the like.

Here, the magnet 125 may be a permanent magnet generating magnetic force having predetermined strength by alternately magnetizing an N pole and an S pole thereof in a circumferential direction.

In addition, the rotor hub 121 may include a first cylindrical wall part 122 fixed to an upper end portion of the shaft 111, a disk part 123 extended from an end portion of the first cylindrical wall part 122 in the outer radial direction, and a second cylindrical wall part 124 protruding downwardly from an end portion of the disk part 123 in the outer radial direction. The second cylindrical wall part 124 may include the magnet 125 coupled to an inner peripheral surface thereof.

The rotor hub 121 may include the main wall part 126 extended downwardly in the axial direction so as to correspond to an outer portion of the upper portion of the sleeve 112. More specifically, the rotor hub 121 may include the main wall part 126 extended from the disk part 123 downwardly in the axial direction and disposed between the sleeve 112 and the holder 114.

A liquid-vapor interface sealing the lubricating fluid may be formed between the outer surface of the sleeve 112 and the inner surface of the main wall part 126. In addition, the labyrinth seal may be formed between the inner surface of the holder 114 and the outer surface of the main wall part 126.

In addition, the inner surface of the main wall part 126 may be tapered, such that an interval between the inner surface of the main wall part 126 and the outer surface of the sleeve 112 may grow wider downwardly in the axial direction, so as to facilitate the sealing of the lubricating fluid. Further, the outer surface of the sleeve 112 may also be tapered to facilitate the sealing of the lubricating fluid.

The stator 130 may include the coil 132, the stator core 131, and the base member 133.

In other words, the stator 130 may be a fixed structure including the coil 132 generating electromagnetic force having a predetermined magnitude when power is applied thereto, and a plurality of stator cores 131 having the coil 132 wound therearound.

The stator core 131 may be disposed above the base member 133 including a printed circuit board (not shown) having circuit patterns printed thereon, a plurality of coil holes having a predetermined size may be formed in the base member 133 corresponding to the winding coil 132 so as to penetrate through the base member 133 in order to expose the winding coil 132 downwardly, and the winding coil 132 may be electrically connected to the printed circuit board (not shown) so that external power may be supplied thereto.

Here, the base member 133 may include the mounting part 134 protruding upwardly in the axial direction.

The base member 133 may be manufactured by performing plastic working on a rolled steel sheet. More specifically, the base member 133 may be manufactured by a pressing method, a stamping method, a deep drawing method, or the like. However, the base member 133 is not limited to being manufactured by the above-mentioned methods, and may be manufactured by various methods that are not described herein.

The base member 133 may be assembled by fitting the mounting part 134 into the space formed between the sleeve 112 and the holder 114 and applying an adhesive to the space formed between the sleeve 112 and the holder 114.

Here, as a method of fixing the mounting part 134 thereto, a sliding method, a press-fitting method, or a welding method, as well as a bonding method, may be used.

Meanwhile, the stator core 131 having the coil 132 wound therearound may be fixedly coupled to the outer surface of the holder 114. In this case, the holder 114 may include the core seating part 114a stepped on the outer surface thereof to allow the lower portion of the stator core 131 to be caught, thereby guiding the fixed position of the stator core 131 and fixing the position of the stator core 131 in the axial direction. Here, the lower surface of the stator core 131 and the core seating part 114a may be bonded to each other.

Further, the stator core 131 may be fitted into and coupled to the outer surface of the holder 114 after the bond is applied to the outer surface of the holder 114. However, the stator core 131 is not limited to being fixed by the above-mentioned method, but may be fixed by various methods such as a sliding method, a press-fitting method, a welding method, and the like.

FIG. 2 is a cross-sectional view showing a spindle motor according to another embodiment of the present invention.

Referring to FIG. 2, a spindle motor 200 according to another embodiment of the present invention is different from the spindle motor 100 according to the embodiment of the present invention described with reference to FIG. 1, in terms of relative positions of the sleeve 112, the holder 114, and the mounting part 134, and a fixed shape of the base member 133. Therefore, a detailed description of the same structure and shape will be omitted in order to prevent confusion and make the description of the present invention clear. Hereinafter, features different from those of the spindle motor 100 described with reference to FIG. 1 will mainly be described.

In the spindle motor 200 according to the embodiment of the present invention, the mounting part 134 of the base member 133 may be fixed to the outer surface of the holder 114. That is, the holder 114 may be directly coupled to the outer surface of the sleeve 112, and the outer surface of the holder 114 may be coupled to the inner surface of the mounting part 134. Here, the sleeve 112 and the holder 114 may be formed integrally with each other.

In the case in which the sleeve 112 and the holder 114 are formed integrally with each other, it may be easy to process the sleeve 112 and the holder 114 simultaneously, to reduce an error range in parallelism between the surface of the core seating part 114a on which the stator core 131 is seated and the upper surface of the sleeve 112 in which the thrust dynamic pressure bearing is formed.

Therefore, the mounting part 134 of the base member 133 may be disposed to face the outer surface of the holder 114. An additional coupling method such as an adhesive bonding method, a sliding method, a press-fitting method, a welding method, or the like, may be similarly utilized.

Meanwhile, since the mounting part 134 is coupled to the outer surface of the holder 114, the stator core 131 may be mounted on the mounting part 134 and the core seating part 114a of the holder 114. More specifically, the mounting part 134 may have the same height as that of the core seating part 114a, and a lower surface of the stator core 131 may be simultaneously coupled to the mounting part 134 and the core seating part 114a.

FIG. 5 is a cross-sectional view showing a spindle motor according to another embodiment of the present invention.

Referring to FIG. 5, a spindle motor 300 according to another embodiment of the present invention is different from the spindle motor 100 according to the embodiment of the present invention described with reference to FIG. 1, in that it includes a connecting part 113 interposed between the sleeve 112 and the holder 114 and a core seating part 114b provided on the upper end of the holder 114 and has a different coupling structure of the base member 133 to the sleeve 112 or the holder 114. Therefore, a detailed description of the same structure and shape will be omitted in order to prevent confusion and make the description of the present invention clear. Hereinafter, features different from those of the spindle motor 100 described with reference to FIG. 1 will mainly be described.

The spindle motor 300 according to the embodiment of the present invention may further include the connecting part 113 interposed between the sleeve 112 and the holder 114.

That is, the sleeve 112 and the holder 114 may be connected to the connecting part 113. The connecting part 113 indicates a portion at which the sleeve 112 and the holder 114 are connected to each other.

Here, the connecting part 113 may have an axial length shorter than those of the sleeve 112 and the holder 114 and connect the sleeve 112 and the holder 114 to each other at approximately central portions thereof in the axial direction. Therefore, upper and lower spaces between the sleeve 112 and the holder 114 may be formed based on the connecting part 113.

Meanwhile, the connecting part 113 may be formed integrally with at least one of the sleeve 112 and the holder 114. That is, the sleeve 112 and the holder 114 may be formed separately from or integrally with each other. That is, the sleeve 112 and the connecting part 113, the connecting part 113 and the holder 114, or the sleeve 112, the connecting part 113, and the holder 114 may be formed integrally with each other, such that the number of components may be reduced. When the number of components is reduced, a product may be manufactured by a single cutting process without coupling between components, so that a coupling tolerance according to coupling between components may not be generated, and thus, a coupling degree of the product may be increased.

In the case in which the sleeve 112 and the holder 114 are formed integrally with each other, it may be easy to process the sleeve 112 and the holder 114 simultaneously, to reduce an error range in parallelism between the surface of the core seating part 114a on which the stator core 131 is seated and the upper surface of the sleeve 112 in which the thrust dynamic pressure bearing is formed.

Further, in the embodiment of the present invention, at least a portion of the holder 114 may be formed of a magnetic material. Therefore, in the case in which the holder 114 is formed integrally with any one member, at least a portion of the member formed integrally with the holder 114 may also be formed of the magnetic material. In the case in which each member is separately formed, only the holder 114 may be formed of the magnetic material.

Further, the sleeve 112 and the holder 114 may include at least one oil injecting hole 113a penetrating therebetween in the axial direction. More specifically, the connecting part 113, a connection portion of the sleeve 112 and the holder 114, may include at least one oil injecting hole 113a penetrating therethrough in the axial direction.

Here, the axial direction may include the same direction as the axial direction or a slightly inclined direction. The oil injecting hole 113a is provided to complete the hydrodynamic bearing assembly 100 and allow oil to be easily injected into the bearing clearance C. The oil may also be injected into the bearing clearance C by other methods, without using the oil injecting hole 113a.

Meanwhile, in the spindle motor 300 according to the present embodiment, the upper end of the holder 114 may be provided with the core seating part 114b protruding outwardly to allow an upper portion of the stator core 131 to be caught, such that a fixed position of the stator core may be guided. The stator core 131 may be bonded to the core seating part 114b.

In this case, parallelism between the surface of the core seating part 114b on which the stator core 131 is seated and the upper surface of the sleeve 112 in which the thrust dynamic pressure bearing is formed may be 50 μm or less, and perpendicularity between the surface of the core seating part 114b on which the stator core 131 is seated and the inner surface of the sleeve 112 in which the radial dynamic pressure bearing is formed may be 50 μm or less. That is, error ranges of the parallelism and the perpendicularity may be 50 μm or less. In the case in which the sleeve 112 and the holder 114 are formed integrally with each other, it may be easy to process the sleeve 112 and the holder 114 simultaneously to reduce the error ranges.

Further, in the spindle motor 300 according to the present embodiment, the base member 133 may include the mounting part 134 protruding upwardly in the axial direction, and the mounting part 134 may be fixed to the holder 114.

In detail, the mounting part 134 protruding from the base member 133 upwardly in the axial direction may be fixed to at least one of the sleeve 112 and the holder 114. In more detail, the mounting part 134 may be fitted into and coupled to the space formed between the sleeve 112 and the holder 114. That is, the mounting part 134 may be fitted into the space formed between the sleeve 112 and the holder 114.

In the case in which the mounting part 134 is fitted into and coupled to the space formed between the sleeve 112 and the holder 114, the mounting part 134 may be bonded to at least one of sleeve 112 and the holder 114. That is, a bond is applied to the space formed between the sleeve 112 and the holder 114, and the mounting part 134 may be slid and coupled to the space to thereby be fixed thereto. In this case, the bond may be applied to at least one of the sleeve 112 and the holder 114.

Further, the coupling method is not limited to the sliding or bonding method, but may also use a press-fitting method, a welding method, or the like. In the case of the press-fitting method, the mounting part 134 may be press-fitted into at least one of the sleeve 112 and the holder 114.

FIG. 6 is a cross-sectional view showing a spindle motor according to another embodiment of the present invention.

Referring to FIG. 6, a spindle motor 400 according to this embodiment of the present invention is different from the spindle motor 300 according to the embodiment of the present invention described with reference to FIG. 5, in terms of the shape of the connecting part connecting the sleeve 112 and the holder 114 and a coupling shape between the sleeve 112 and the base member 133. Therefore, a detailed description of the same structure and shape will be omitted in order to prevent confusion and make the description of the present invention clear. Hereinafter, features different from those of the spindle motor 300 described with reference to FIG. 5 will mainly be described.

The connecting part 113 used in the spindle motor 400 according to the embodiment of the present invention may connect the sleeve 112 and the holder 114 to each other. In addition, the connecting part 113 may have an axial length slightly shorter than those of the sleeve 112 and the holder 114.

However, the connecting part 113 may connect the sleeve 112 and the holder 114 to each other at a lower portion of the holder 114 in the axial direction. Therefore, a space between the sleeve 112 and the holder 114 may be formed above the connecting part 113, but may not be formed thereunder.

Therefore, the mounting part 134 of the base member 133 may be disposed to face the lower surface of the holder 114. An additional coupling method such as an adhesive bonding method, a sliding method, a welding method, or the like, may be similarly utilized. Since the mounting part 134 is coupled to the holder 114, an outer surface of the lower portion of the sleeve 112 may be inclined inwardly from an upper portion thereof toward a lower portion thereof. Due to this shape, an adhesive may be easily applied thereto or welding may be facilitated.

FIG. 7 is a cross-sectional view showing a spindle motor according to another embodiment of the present invention.

Referring to FIG. 7, a spindle motor 500 according to the embodiment of the present invention is different from the spindle motor 300 according to the embodiment of the present invention described with reference to FIG. 5, in terms of the a position of a core seating part 114c provided in the holder 114. Therefore, a detailed description of the same structure and shape will be omitted in order to prevent confusion and make the description of the present invention clear. Hereinafter, features different from those of the spindle motor 300 described with reference to FIG. 5 will mainly be described.

The core seating part 114c used in the spindle motor 500 according to the embodiment of the present invention protrudes outwardly from the holder 114 to allow the lower portion of the stator core 131 to be caught, such that a fixed position of the stator core 131 may be guided thereby. That is, unlike the spindle motor 300 according to the embodiment of the present invention described with reference to FIG. 5, the core seating part 114c may be positioned lower than the stator core 131 in the axial direction. The stator core 131 may be bonded to the core seating part 114c.

Further, the core seating part 114c may have the same shape as that of the core seating part 114a shown in FIGS. 3 and 4.

Although a shaft-rotating type structure in which the rotor hub is coupled to the shaft to rotate has been described in the embodiments of FIGS. 1 through 7, the present invention may also have a shaft-fixing type structure in which the rotor hub is coupled to the sleeve to rotate.

FIG. 8 is a cross-sectional view of a disk driving device using a spindle motor according to an embodiment of the present invention.

Referring to FIG. 8, a recording disk driving device 800 including the spindle motor 100, 200, 300, 400, or 500 according to the embodiment of the present invention mounted therein may be a hard disk driving device and include the spindle motor 100, 200, 300, 400, or 500, a head transfer part 810, and a housing 820.

The spindle motor 100, 200, 300, 400, or 500 has all the characteristics of the spindle motor according to the embodiments of the present invention described above and may have a recording disk 830 mounted thereon.

The head transfer part 810 may transfer a magnetic head 815 detecting information of the recording disk 830 mounted on the spindle motor 100, 200, 300, 400, or 500 to a surface of the recording disk from which information is to be read.

Here, the magnetic head 815 may be disposed on a support 817 of the head transfer part 810.

In order to form an internal space receiving the spindle motor 100, 200, 300, 400, or 500 and the head transfer part 810, the housing 820 may include a motor mounting plate 822 and a top cover 824 disposed above the motor mounting plate 822 to shield the internal space.

As set forth above, a spindle motor according to embodiments of the present invention includes a holder capable of allowing magnetic flux to flow smoothly while using a base manufactured by plastic working such as press working or the like, whereby a core may be stably and easily mounted.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a shaft;
a sleeve rotatably supporting the shaft by fluid dynamic pressure;
a holder provided outwardly of the sleeve and at least partially formed of a magnetic material;
a stator core mounted on an outer surface of the holder; and
a base member including a mounting part protruding upwardly in an axial direction and fixed to the holder,
wherein the holder has a core seating part protruding outwardly therefrom, and an upper surface of the stator core is seated on the core seating part.

2. The spindle motor of claim 1, wherein the mounting part is fitted between the sleeve and the holder.

3. The spindle motor of claim 1, wherein the mounting part is coupled to the outer surface of the holder in a radial direction.

4. The spindle motor of claim 1, further comprising a connecting part interposed between the sleeve and the holder.

5. The spindle motor of claim 4, wherein the connecting part is formed integrally with at least one of the sleeve and the holder.

6. The spindle motor of claim 1, wherein the upper surface of the stator core is bonded to the core seating part.

7. The spindle motor of claim 1, further comprising a rotor hub coupled to an upper end of the shaft,
wherein the rotor hub includes a main wall part extended downwardly in the axial direction and having an inner surface facing at least a portion of an outer surface of the sleeve and an outer surface facing at least a portion of an inner surface of the holder.

8. The spindle motor of claim 7, wherein the outer surface of the main wall part and the inner surface of the holder form a labyrinth seal.

9. The spindle motor of claim 1, wherein the base member is formed by performing plastic working on a rolled steel sheet.

10. The spindle motor of claim 1, wherein the holder is entirely formed of a magnetic material.

11. The spindle motor of claim 1, wherein the holder is formed by plating or coating a non-magnetic metal with a magnetic metal.

12. The spindle motor of claim 1, wherein the holder is formed by performing corrosion resistant coating or painting on a magnetic metal.

13. A hard disk drive comprising:
the spindle motor of claim 1 rotating a disk by power applied through a substrate;
a magnetic head writing data to the disk and reading data from the disk; and
a head transfer part transferring the magnetic head to a predetermined position on the disk.
